(19) United States
(12) Patent Application Publication
(10) Pub. No.: US 2005/0067002 A1
(43) Pub. Date: Mar. 31, 2005

(54) Processing chamber including a circulation loop integrally formed in a chamber housing

(75) Inventor: William Dale Jones, Phoenix, AZ (US)

Correspondence Address: HAVERSTOCK & OWENS LLP, 162 NORTH WOLFE ROAD, SUNNYVALE, CA, 94086, US

(73) Assignee: Supercritical Systems, Inc.

(21) Appl. No.: 10/672,264

(22) Filed: Sep. 25, 2003

(51) Int. Cl. B08B 3/02

(52) U.S. Cl. 134/25.4; 134/33; 134/34; 134/186; 134/902; 134/111

(57) ABSTRACT

An apparatus for and method of processing an object with a processing fluid. The apparatus comprises a processing chamber formed within a chamber housing and a fluid circulation loop integrally formed in the chamber housing. The method includes the step of circulating a fluid stream within a fluid circulation loop integrally formed in a chamber housing. The method also includes the step of generating a high-velocity fluid stream within a processing chamber.

### FIELD OF THE INVENTION

The present invention in general relates to the field of removing residues and contaminants in the fabrication of semiconductor devices or other objects. More particularly, the present invention relates to processing an object with a high-velocity fluid stream within a processing chamber.

### BACKGROUND OF THE INVENTION

It has been observed that effective cleaning of wafers with supercritical carbon dioxide can be enhanced by adding solvents and co-solvents to the carbon dioxide. The solvents and co-solvents in the carbon dioxide work chemically with the carbon dioxide to dissolve the contamination on the surface of the wafer.

Because carbon dioxide must be maintained at high pressure to achieve the supercritical state, the size of the process chamber and the plumbing should be designed to be of the minimum dimensions to achieve an economical design. Economy of design is achieved by reducing the volume of the process chamber and process loop, thereby reducing the quantity of carbon dioxide, solvents and co-solvents necessary to clean the substrate and reducing the size and weight of the process chamber and process plumbing. High velocity over the surface of the substrate implies high volume flow rate of the supercritical carbon dioxide. The high volume flow rate requires large flow passages to avoid high pressure drop as the supercritical carbon dioxide circulates during the cleaning process. If the supercritical carbon dioxide must exit the process chamber, flow through tubes, and return to the process chamber as it circulates, the flow control components, plumbing, and fittings necessary to contain the pressure become large, thereby increasing the cost of the design and the volume of the process loop that contains the supercritical carbon dioxide, solvents, and co-solvents. It is desirable to have a design that enables passing supercritical carbon dioxide over the surface of the substrate without increasing the size of the process plumbing.

### SUMMARY OF THE INVENTION

A first embodiment of the present invention is an apparatus for processing an object with a processing fluid. The apparatus includes a processing chamber formed within a chamber housing. A fluid circulation loop is integrally formed in the chamber housing.

A second embodiment of the invention is an apparatus for processing an object with a processing fluid. The apparatus includes a chamber housing defining a processing chamber. The chamber housing includes a fluid inlet means and a fluid outlet means in communication with the processing chamber. The chamber housing includes a fluid circulation loop integrally formed in the chamber housing. The fluid circulation loop couples the fluid inlet means and the fluid outlet means. The apparatus also includes a flow generating means for receiving a fluid and generating a high-velocity fluid. The flow generating means is coupled to the fluid circulation loop. The apparatus also includes a fluid supply means for supplying a processing fluid to the processing chamber including at least one fluid source.

A third embodiment is a semiconductor wafer processing apparatus. The semiconductor wafer processing apparatus includes a processing chamber formed within a chamber housing. The chamber housing has a fluid inlet and a fluid outlet in communication with the processing chamber. The wafer processing apparatus includes a first fluid communication line integrally formed in the chamber housing and coupling the fluid outlet and the fluid inlet. The first fluid communication line includes a pump for generating a high-velocity fluid stream. The apparatus also includes a filtering means for filtering a fluid.

A fourth embodiment is a method of processing an object with a processing fluid. The method includes the step of circulating a fluid stream within a fluid circulation loop integrally formed in a chamber housing. The method also includes the step of generating a high-velocity fluid stream within a processing chamber.

A fifth embodiment is a method of removing at least a portion of a residue from a surface of a semiconductor wafer. The method includes the step of increasing a frictional force of the processing fluid over the surface of the semiconductor wafer by generating a high-velocity processing fluid stream. The method includes the step of circulating the processing fluid within a fluid circulation loop integrally formed in a chamber housing.

A sixth embodiment is a method of making a supercritical processing apparatus, comprising the steps of: forming a processing chamber within a chamber housing; and integrally forming a fluid circulation loop into the chamber housing for generating a high-velocity fluid stream within the processing chamber.

### BRIEF DESCRIPTION OF THE DRAWINGS

The present invention may be better understood by reference to the accompanying drawings of which:

FIGS. 1A to 1B are schematic illustrations of an apparatus for processing an object with a processing fluid, in accordance with embodiments of the present invention.

FIG. 2 is a schematic illustration of alternative embodiments of the apparatus shown in FIG. 1A.

FIG. 3 is a schematic illustration of a semiconductor wafer processing apparatus, in accordance with embodiments of the present invention.

FIG. 4 is a schematic illustration of an alternative embodiment of the semiconductor wafer processing apparatus shown in FIG. 3.

FIG. 5 is a flow chart showing a method of processing an object with a processing fluid, in accordance with embodiments of the present invention.

FIG. 6 is a flow chart showing a method of removing at least a portion of a residue from a surface of a semiconductor wafer, in accordance with embodiments of the present invention.

FIG. 7 is a flow chart showing a method of making a supercritical processing apparatus, in accordance with embodiments of the present invention.

In the drawings, like reference numbers are used when describing the same elements. Additionally, the left-most digit(s) of a reference number typically identifies the drawings in which the reference number first appears.

### DETAILED DESCRIPTION OF THE PREFERRED EMBODIMENTS

The present invention is directed to an apparatus for processing an object with a processing fluid. For the purposes of the invention and this disclosure, “fluid” means a gaseous, liquid, supercritical and/or near-supercritical fluid. In certain embodiments of the invention, “fluid” means gaseous, liquid, supercritical and/or near-supercritical carbon dioxide. It should be appreciated that solvents, co-solvents, chemistries, and/or surfactants can be contained in the carbon dioxide. For purposes of the invention, “carbon dioxide” should be understood to refer to carbon dioxide (CO₂) employed as a fluid in a liquid, gaseous or supercritical (including near-supercritical) state. “Supercritical carbon dioxide” refers herein to CO₂ at conditions above the critical temperature (30.5° C.) and critical pressure (7.38 MPa). When CO₂ is subjected to pressures and temperatures above 7.38 MPa and 30.5° C., respectively, it is determined to be in the supercritical state. “Near-supercritical carbon dioxide” refers to CO₂ within about 85% of critical temperature and critical pressure. For the purposes of the invention,“object” typically refers to a semiconductor wafer for forming integrated circuits, a substrate and other media requiring low contamination levels. As used herein, “substrate” includes a wide variety of structures such as semiconductor device structures typically with a deposited photoresist or residue. A substrate can be a single layer of material, such as a silicon wafer, or can include any number of layers. A substrate can comprise various materials, including metals, ceramics, glass, or compositions thereof.

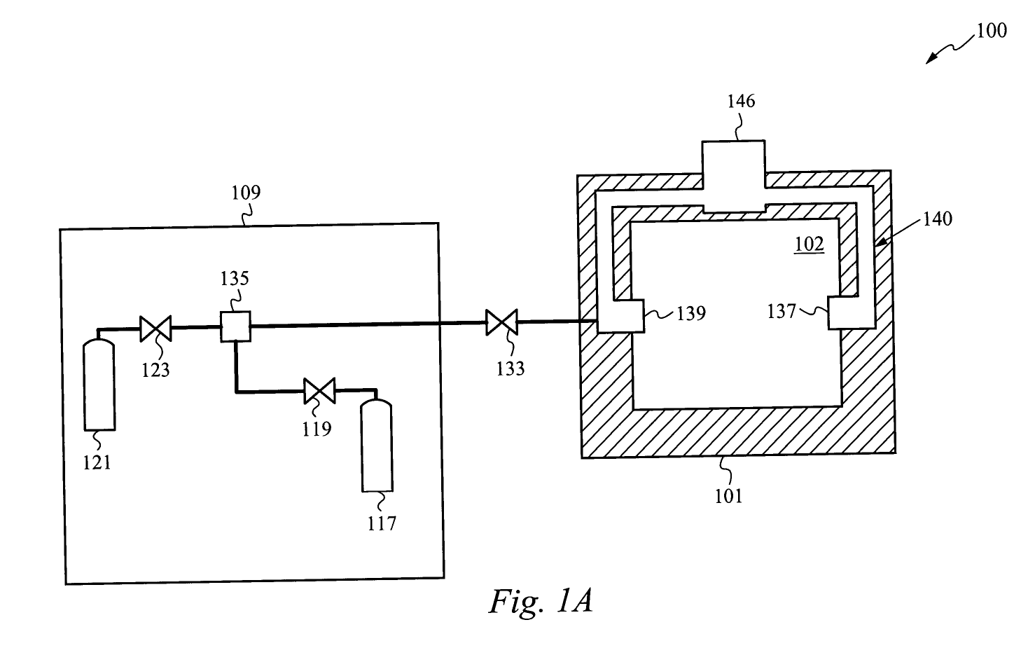

FIG. 1 is a schematic illustration of an apparatus 100 for processing an object with a processing fluid, in accordance with embodiments of the present invention. In the preferred embodiment of the invention, the apparatus 100 includes a processing chamber 102 formed within a chamber housing 101. The details concerning one example of a processing chamber are disclosed in co-owned and co-pending U.S. patent applications, Ser. No. 09/912,844, entitled “HIGH PRESSURE PROCESSING CHAMBER FOR SEMICONDUCTOR SUBSTRATE,” filed Jul. 24, 2001, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are incorporated herein by reference.

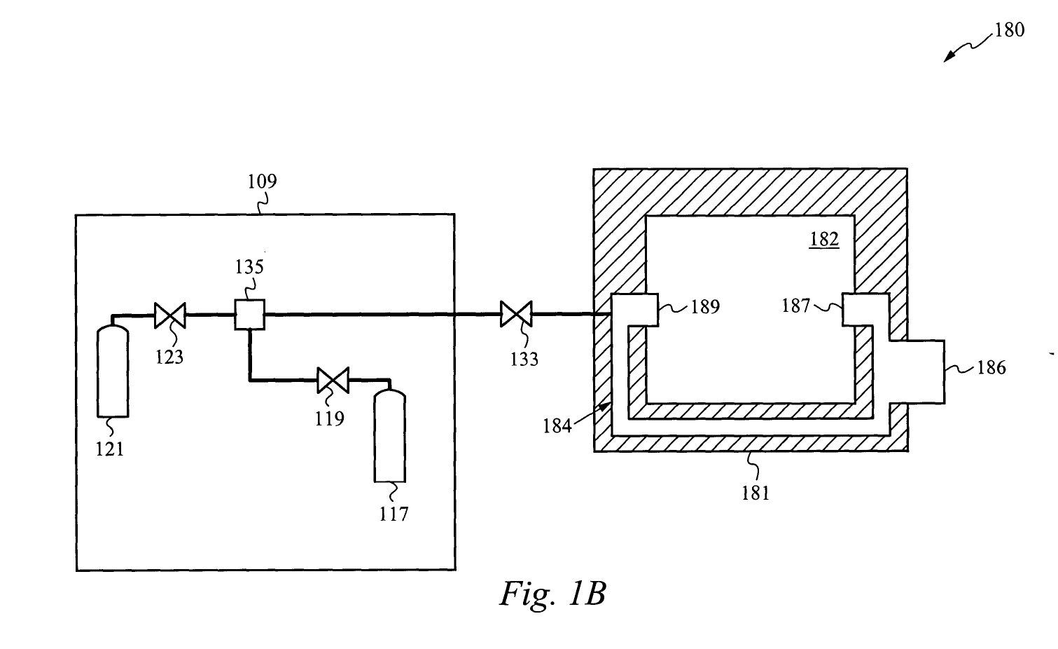

In accordance with the preferred embodiment of the invention, the apparatus 100 includes a fluid circulation loop 140 integrally formed in the chamber housing 101. Preferably, the fluid circulation loop 140 includes a flow generating means 146 for receiving a fluid and generating a high-velocity fluid stream. In certain embodiments, the flow generating means 146 is configured to receive a fluid from the fluid outlet means 137 shown in FIG. 1. In certain embodiments, such as depicted in FIG. 2, the flow generating means 246 is configured to receive a fluid from at least one of the fluid supply means 109, as indicated by the dotted line, and the fluid outlet means 237. As FIG. 2 depicts, in one embodiment, the fluid supply means 109 is coupled to the process chamber 202.

As shown in FIG. 1, in one embodiment of the invention, the chamber housing 101 comprises a fluid inlet means 139 and a fluid outlet means 137 in communication with the processing chamber; a fluid circulation loop 140 coupling the fluid inlet means 139 and the fluid outlet means 137; and a flow generating means 146 for receiving a fluid and generating a high-velocity fluid. Preferably, the flow generating means 146 is a pump coupled to the fluid circulation loop 140. In one embodiment of the invention, apparatus 100 includes a back-flow blocking means (not shown). Preferably, the back-flow blocking means is adapted and positioned for allowing a fluid to flow unidirectionally from within the processing chamber 102 to the flow generating means 146. In one embodiment, the back-flow blocking means comprises at least one check valve.

In one embodiment of the invention, the apparatus 100 includes a filtering means (not shown) for filtering the processing fluid is provided. Preferably, the filtering means is in fluid communication with the fluid circulation loop 140. Preferably, the filtering means is configured to reduce a contaminant level of the processing fluid. Any means for filtering a processing fluid to reduce a contaminant level of the processing fluid should be should be suitable for implementing the present invention. In certain embodiments, the filtering means is configured to have either or both of a course filter and a fine filter.

In one embodiment, apparatus 100 includes a means for recirculating the processing fluid within the processing chamber 102 for a period of time to remove a contaminant from a surface of the object. In certain embodiments, the object is a semiconductor wafer for forming integrated circuits. Preferably, the processing fluid comprises at least one of gaseous, liquid, supercritical and near-supercritical carbon dioxide. It should be appreciated that solvents, co-solvents, chemistries, and/or surfactants can be contained in the carbon dioxide.

As FIG. 1 depicts, in one embodiment, apparatus 100 includes a fluid supply means 109 for supplying the processing fluid to the processing chamber 102. It should be appreciated that the fluid supply means 109 can include any combination of a fluid mixer 135, a first fluid source 121 in fluid communication with the mixer 135, a valve 123 for controlling a flow of a first fluid from the first fluid source to the mixer 135, a second fluid source 117 in fluid communication with the mixer 135, and a valve 119 for controlling a flow of a second fluid from the second fluid source to the mixer 135. In certain embodiments, either or both of the first fluid source 121 and the second fluid source 117 supply solvents, co-solvents, chemistries, and/or surfactants. Preferably, either or both of the first fluid source 121 and the second fluid source 117 supply gaseous, liquid, supercritical and/or near-supercritical carbon dioxide. It should be appreciated that solvents, co-solvents, chemistries, and/or surfactants can be contained in the carbon dioxide. In one embodiment, a flow-control means 133 for controlling a flow of the processing fluid is provided, such as a valve.

In one embodiment of the invention, a means for introducing a processing chemistry into the fluid circulation loop 140 is provided. In one embodiment, the apparatus 100 includes a means for maintaining a temperature of at least one of a fluid within the processing chamber 102 and a fluid within the fluid circulation loop 140.

In certain embodiments of the invention, the fluid inlet means 139 is adapted to direct the high-velocity fluid stream over the object. Preferably, the fluid inlet means 139 is further adapted to allow substantially all the high-velocity fluid stream to pass over the object within a predetermined distance from a surface of the object. In certain embodiments, the fluid inlet means 139 includes a manifold having a plurality of fluid outlets for directing the high-velocity fluid stream over the object. In one embodiment, the manifold comprises an injection ring. In one embodiment of the invention, a small volume of supercritical carbon dioxide is circulated through passages and flow-control components, then injected over the object in such a manner as to generate high-velocity fluid circulation over the surface of the object that is effective in removing contaminants. In one embodiment, a large volume of supercritical carbon dioxide is circulated through passages and flow-control components that are integral to the processing chamber 102 or integral to blocks attached to the processing chamber 102. By this means, the requirement for fittings and plumbing that increase the size and volume of the fluid circulation loop 140 is avoided.

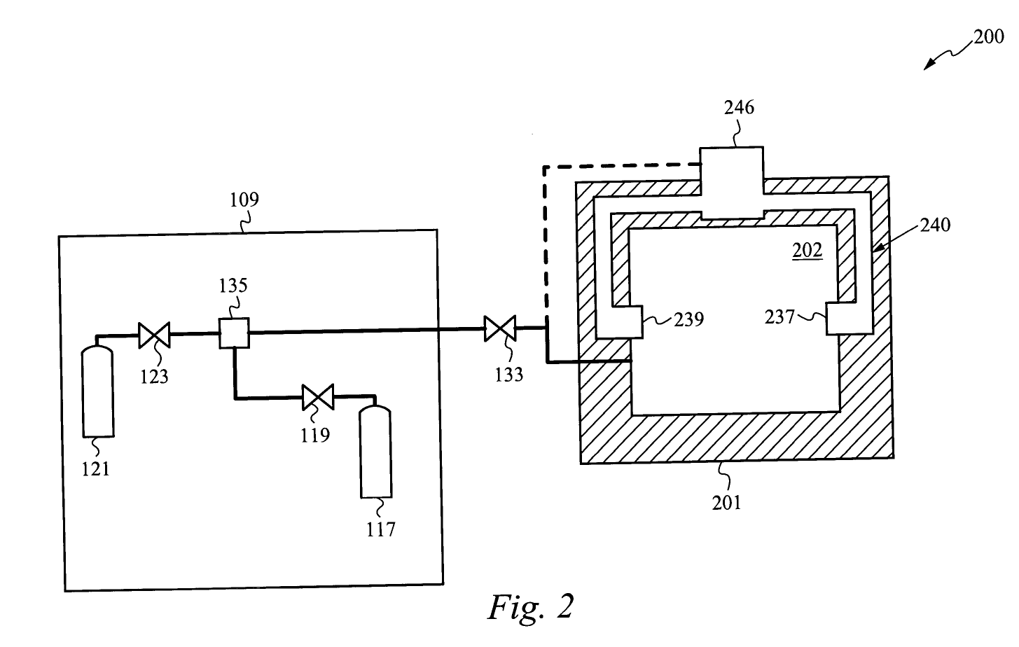

FIG. 3 is a schematic illustration of a semiconductor wafer processing apparatus 300, in accordance with embodiments of the present invention. As FIG. 3 depicts, the semiconductor wafer processing apparatus 300 includes a processing chamber 302 formed within a chamber housing 301. Preferably, the chamber housing 301 includes a fluid inlet 339 and a fluid outlet 337 in communication with the processing chamber 302. In certain embodiments, the semiconductor wafer processing apparatus 300 includes a fluid communication line 340 coupling the fluid outlet 337 and the fluid inlet 339. Preferably, the fluid communication line 340 is integrally formed in the chamber housing 301. Preferably, the fluid communication line 340 includes a pump 346 for generating a high-velocity fluid stream.

As shown in FIG. 3, in one embodiment of the invention, the apparatus 300 includes a filtering means 343 for filtering the processing fluid. Preferably, the filtering means 343 is coupled to the fluid communication line 340. Preferably, the filtering means 343 is configured to reduce a contaminant level of the processing fluid. Any means for filtering a processing fluid to reduce a contaminant level of the processing fluid should be should be suitable for implementing the present invention. In certain embodiments, the filtering means 343 is configured to have either or both of a course filter and a fine filter.

In certain embodiments of the invention, the fluid inlet means 339 is adapted to direct the high-velocity fluid stream over the object. Preferably, the fluid inlet means 339 is further adapted to allow substantially all the high-velocity fluid stream to pass over the object within a predetermined distance from a surface of the object. In certain embodiments, the fluid inlet means 339 includes a manifold having a plurality of fluid outlets for directing the high-velocity fluid stream over the object. In one embodiment, the manifold comprises an injection ring.

In one embodiment of the invention, semiconductor wafer processing apparatus 300 includes a back-flow blocking means (not shown). Preferably, the back-flow blocking means is adapted and positioned for allowing a processing fluid to flow unidirectionally from the fluid outlet 337 to the fluid inlet 339. In one embodiment, the back-flow blocking means is adapted and positioned for allowing a processing fluid to flow unidirectionally from within the processing chamber 302 to the pump 346. In one embodiment, the back-flow blocking means comprises at least one check valve.

According to certain embodiments, semiconductor wafer processing apparatus 300 includes a fluid supply means 309 for supplying a processing fluid to the processing chamber including at least one fluid source. It should be appreciated that the fluid supply means 309 can include any combination of a fluid mixer 335, a first fluid source 121 in fluid communication with the mixer 335, a first valve 323 for controlling a flow of a first fluid from the first fluid source to the mixer 335, a second fluid source 117 in fluid communication with the mixer 335, and a second valve 319 for controlling a flow of a second fluid from the second fluid source to the mixer 335. In certain embodiments, either or both of the first fluid source 121 and the second fluid source 117 supply solvents, co-solvents, chemistries, and/or surfactants. Preferably, either or both of the first fluid source 121 and the second fluid source 117 supply gaseous, liquid, supercritical and/or near-supercritical carbon dioxide. It should be appreciated that solvents, co-solvents, chemistries, and/or surfactants can be contained in the carbon dioxide. In one embodiment, a flow-control means 333 for controlling a flow of the processing fluid is provided, such as a valve. In certain embodiments, a process control computer 350 is coupled for controlling the first valve 323, mixer 335, second valve 319, flow-control means 333, and/or the pump 346, as shown by the dotted lines in FIG. 3.

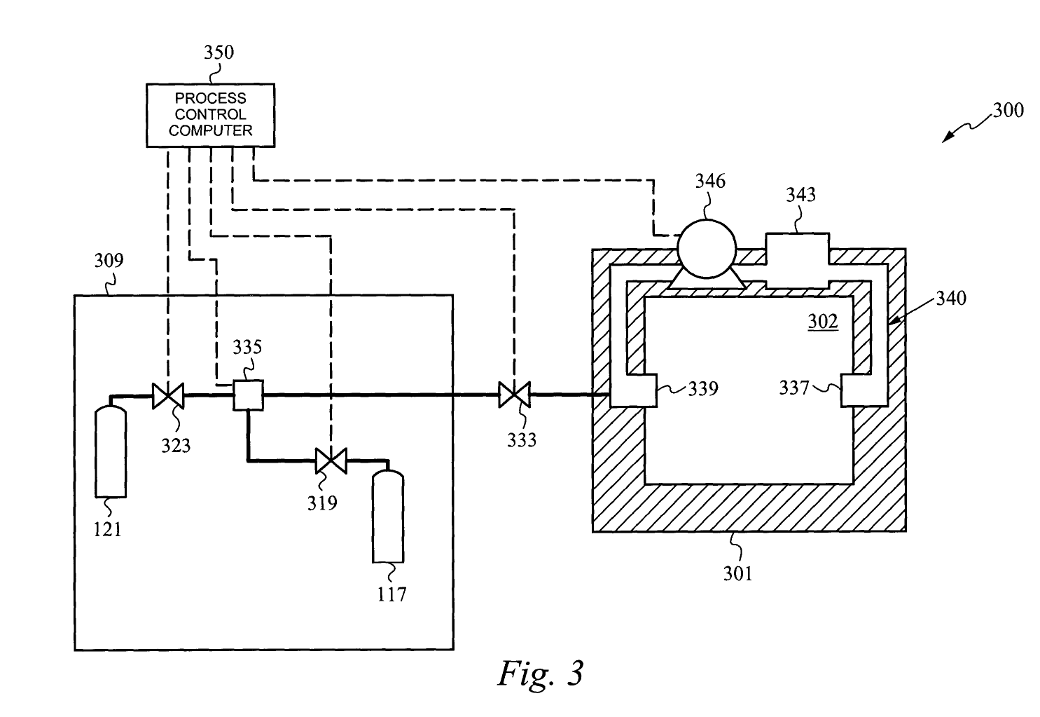

FIG. 4 is a schematic illustration of an alternative embodiment of the semiconductor wafer processing apparatus shown in FIG. 3. As FIG. 4 depicts, a semiconductor wafer processing apparatus 400 includes a processing chamber 402 formed within a chamber housing 401.

In certain embodiments of the invention, the chamber housing 401 includes a first fluid inlet 449 and a first fluid outlet 447 in communication with the processing chamber 402. Preferably, the semiconductor wafer processing apparatus 400 includes a first fluid communication line 440 coupling the first fluid outlet 447 and the first fluid inlet 439. Preferably, the first fluid communication line 440 is integrally formed in a wall of the chamber housing 401. In one embodiment, the first fluid communication line 440 includes a first pump 446 for generating a high-velocity fluid stream. In one embodiment, a first filtering means 443 is coupled to the first fluid communication line 440. Preferably, the first filtering means 443 is configured to reduce a contaminant level of the processing fluid.

According to certain embodiments, the chamber housing 401 also includes a second fluid inlet 459 and a second fluid outlet 457 in communication with the processing chamber 402. Preferably, the apparatus 400 includes a second fluid communication line 450 coupling the second fluid outlet 457 and the second fluid inlet 459. Preferably, the second fluid communication line 450 is integrally formed in a wall of the chamber housing 401. In one embodiment, the second fluid communication line 450 includes a second pump 456 for generating a high-velocity fluid stream. In one embodiment, a second filtering means 453 is coupled to the second fluid communication line 450. Preferably, the second filtering means 453 is configured to reduce a contaminant level of the processing fluid.

According to certain embodiments, the semiconductor wafer processing apparatus 400 includes a fluid supply means 309 for supplying a processing fluid to the processing chamber including at least one fluid source. It should be appreciated that the fluid supply means 309 can include any combination of a fluid mixer 335, a first fluid source 121 in fluid communication with the mixer 335, a valve 323 for controlling a flow of a first fluid from the first fluid source to the mixer 335, a second fluid source 117 in fluid communication with the mixer 335, and a valve 319 for controlling a flow of a second fluid from the second fluid source to the mixer 335. In certain embodiments, either or both of the first fluid source 121 and the second fluid source 117 supply solvents, co-solvents, chemistries, and/or surfactants. Preferably, either or both of the first fluid source 121 and the second fluid source 117 supply gaseous, liquid, supercritical and/or near-supercritical carbon dioxide. It should be appreciated that solvents, co-solvents, chemistries, and/or surfactants can be contained in the carbon dioxide. In one embodiment, a flow-control means 333 such as a valve is provided for controlling a flow of the processing fluid. In certain embodiments, a process control computer 350 is coupled for controlling the first valve 323, mixer 335, second valve 319, flow-control means 333, and/or the pump 446, as shown by the dotted lines in FIG. 4.

In certain embodiments, fluid supply means 309 is coupled into one of the first fluid communication line 440 or the second fluid communication line 450 for controllably allowing a fluid from the fluid supply means 309 to enter the semiconductor wafer processing apparatus 400.

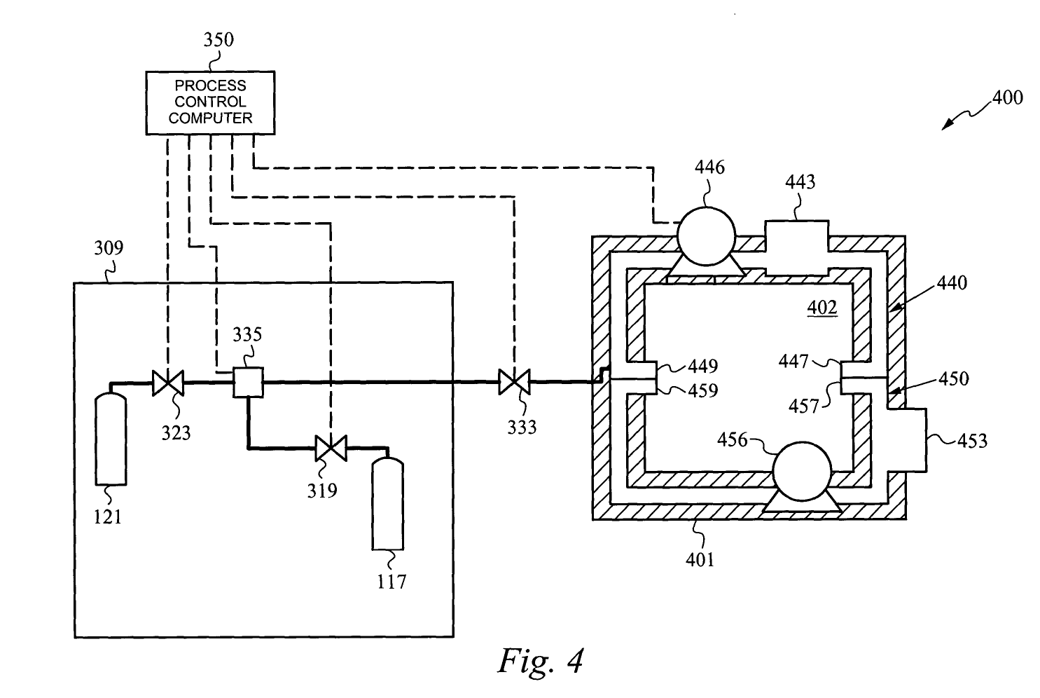

FIG. 5 is a flow chart showing a method of processing an object with a processing fluid, in accordance with embodiments of the present invention. In step 510, a fluid stream is circulated within a fluid circulation loop integrally formed in a chamber housing. In step 520, a high-velocity fluid stream is generated within a processing chamber.

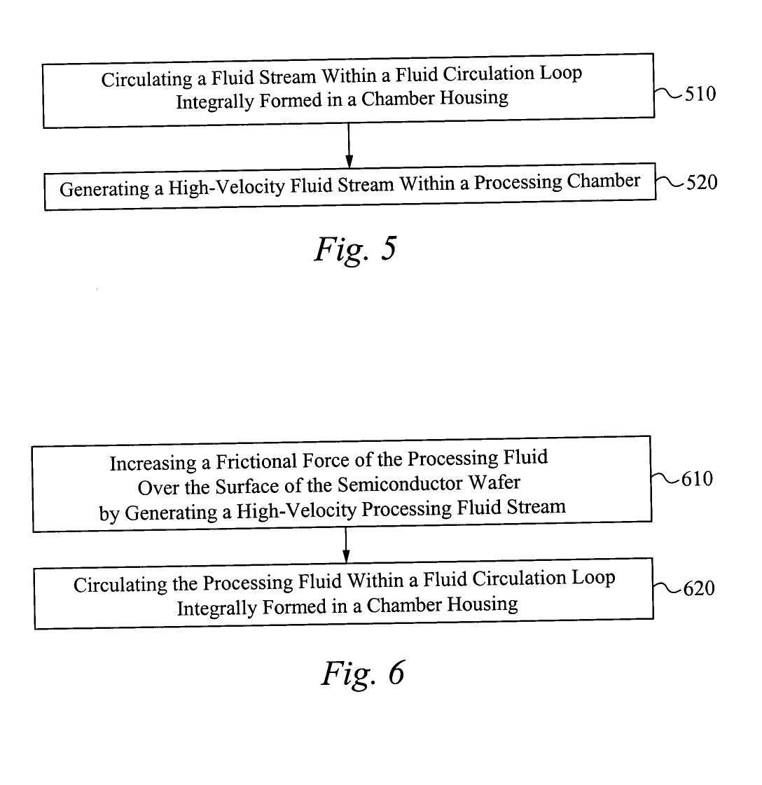

FIG. 6 is a flow chart showing a method of removing at least a portion of a residue from a surface of a semiconductor wafer with a processing fluid. In step 610, a frictional force of the processing fluid is increased over the surface of the semiconductor wafer by generating a high-velocity processing fluid stream. In step 620, the processing fluid is circulated within a fluid circulation loop integrally formed in a chamber housing.

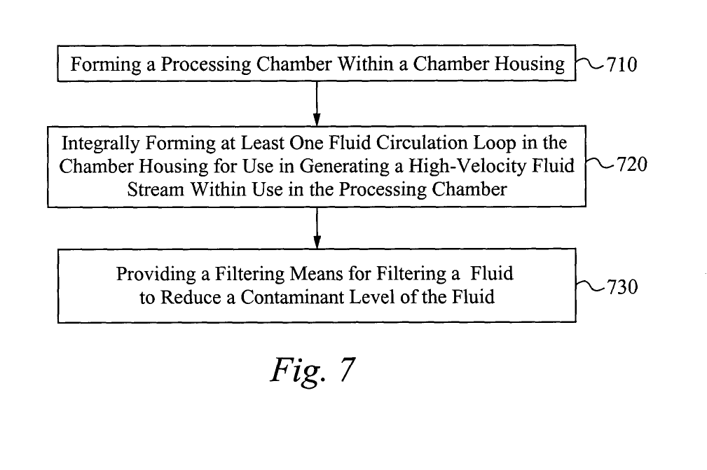

FIG. 7 is a flow chart showing a method of making a supercritical processing apparatus, in accordance with embodiments of the present invention. In step 710, a processing chamber is formed within a chamber housing. In step 720, at least one fluid circulation loop is integrally formed in the chamber housing for use in generating a high-velocity fluid stream within the processing chamber. In an optional step 730, a filtering means is provided for filtering a fluid to reduce a contaminant level of the fluid.

While the processes and apparatus of this invention have been described in detail for the purpose of illustration, the inventive processes and apparatus are not to be construed as limited thereby. It will be readily apparent to those of reasonable skill in the art that various modifications to the foregoing preferred embodiments can be made without departing from the spirit and scope of the invention as defined by the appended claims.

1. An apparatus for processing an object with a processing fluid, comprising:
a processing chamber formed within a chamber housing; and
a fluid circulation loop integrally formed in the chamber housing.

2. The apparatus of claim 1 wherein the fluid circulation loop comprises flow generating means for receiving a fluid and generating a high-velocity fluid stream.

3. The apparatus of claim 1 further comprising back-flow blocking means adapted and positioned for allowing the processing fluid to flow unidirectionally from within the processing chamber to the flow generating means.

4. The apparatus of claim 3 further comprising filtering means for filtering the processing fluid.

5. The apparatus of claim 1 further comprising fluid supply means for supplying a fluid to the processing chamber.

6. The apparatus of claim 1 wherein the object is a semiconductor wafer for forming integrated circuits.

7. The apparatus of claim 1 further comprising means for recirculating the processing fluid within the processing chamber for a period of time to remove a contaminant from a surface of the object.

8. The apparatus of claim 1 further comprising means for introducing a processing chemistry into the fluid circulation loop.

9. The apparatus of claim 1 further comprising means for maintaining a temperature of at least one of a fluid within the processing chamber and a fluid within the fluid circulation loop.

10. An apparatus for processing an object with a processing fluid, comprising:
a. a chamber housing defining a processing chamber, the chamber housing comprising:
i. fluid inlet means and fluid outlet means in communication with the processing chamber;
ii. a fluid circulation loop integrally formed in the chamber housing, the fluid circulation loop coupling the fluid inlet means and the fluid outlet means; and
iii. flow generating means for receiving a fluid and generating a high-velocity fluid, the flow generating means coupled to the fluid circulation loop; and
b. fluid supply means for supplying a processing fluid to the processing chamber including at least one fluid source.

11. The apparatus of claim 10 wherein the fluid inlet means is adapted to direct the high-velocity fluid stream over the object.

12. The apparatus of claim 11 wherein the fluid inlet means is further adapted to allow substantially all the high-velocity fluid stream to pass over the object within a predetermined distance from a surface of the object.

13. The apparatus of claim 12 further comprising a manifold having a plurality of fluid outlets for directing the high-velocity fluid stream over the object.

14. The apparatus of claim 13 wherein the manifold comprises an injection ring.

15. The apparatus of claim 10 wherein the flow generating means is configured to receive a fluid from at least one of the fluid supply means and the fluid outlet means.

16. The apparatus of claim 10 further comprising back-flow blocking means adapted and positioned for allowing the processing fluid to flow unidirectionally from within the processing chamber to the flow generating means.

17. The apparatus of claim 16 wherein the back-flow blocking means comprises at least one check valve.

18. The apparatus of claim 10 wherein the object is a semiconductor wafer for forming integrated circuits.

19. The apparatus of claim 10 further comprising means for recirculating the processing fluid within the processing chamber for a period of time to remove a contaminant from a surface of the object.

20. The apparatus of claim 10 wherein the fluid comprises at least one of gaseous, liquid, supercritical and near-supercritical carbon dioxide.

21. The apparatus of claim 20 wherein at least one of solvents, co-solvents, chemistries, and surfactants are contained in the carbon dioxide.

22. The apparatus of claim 10 further comprising filtering means for filtering the processing fluid.

23. The apparatus of claim 22 wherein the filtering means is configured to reduce a contaminant level of the processing fluid.

24. The apparatus of claim 23 wherein the filtering means is further configured to have at least one of a course filter and a fine filter.

25. The apparatus of claim 10 further comprising fluid supply means for supplying a fluid from the fluid source to the processing chamber.

26. A semiconductor wafer processing apparatus, comprising:
a processing chamber formed within a chamber housing, the chamber housing having a fluid inlet and a fluid outlet in communication with the processing chamber;
a first fluid communication line integrally formed in the chamber housing and coupling the fluid outlet and the fluid inlet, the first fluid communication line including a pump for generating a high-velocity fluid stream; and
filtering means for filtering the processing fluid.

27. The semiconductor wafer processing apparatus of claim 26 wherein the fluid inlet is adapted to direct the processing fluid over the object.

28. The semiconductor wafer processing apparatus of claim 26 wherein the fluid communication line includes a back-flow blocking means adapted for allowing a processing fluid to flow unidirectionally from the fluid outlet to the fluid inlet.

29. The semiconductor wafer processing apparatus of claim 28 wherein the back-flow blocking means comprises at least one check valve.

30. The semiconductor wafer processing apparatus of claim 26 wherein the filtering means is coupled to the fluid communication line.

31. The semiconductor wafer processing apparatus of claim 26 wherein the filtering means is configured to reduce a contaminant level of the processing fluid.

32. The semiconductor wafer processing apparatus of claim 31 wherein the filtering means is further configured to have at least one of a course filter and a fine filter.

33. The semiconductor wafer processing apparatus of claim 26 further comprising a second fluid communication line integrally formed in the chamber housing and coupling the fluid outlet and the fluid inlet, the second fluid communication line including a pump for generating a high-velocity fluid stream.

34. The semiconductor wafer processing apparatus of claim 26 further comprising fluid supply means for supplying a processing fluid to the processing chamber including at least one fluid source.

35. A method of processing an object with a processing fluid, comprising the steps of:
a. circulating a fluid stream within a fluid circulation loop integrally formed in a chamber housing; and
b. generating a high-velocity fluid stream within a processing chamber.

36. A method of removing at least a portion of a residue from a surface of a semiconductor wafer with a processing fluid, comprising the steps of:
a. increasing a frictional force of the processing fluid over the surface of the semiconductor wafer by generating a high-velocity processing fluid stream; and
b. circulating the processing fluid within a fluid circulation loop integrally formed in a chamber housing.

37. A method of making a supercritical processing apparatus, comprising the steps of:
a. forming a processing chamber within a chamber housing; and
b. integrally forming at least one fluid circulation loop in the chamber housing for use in generating a high-velocity fluid stream within the processing chamber.

38. The method of claim 37 further comprising the step of providing a filtering means for filtering a fluid to reduce a contaminant level of the fluid.
